(19) United States
(12) Patent Application Publication
(10) Pub. No.: US 2014/0136736 A1
(43) Pub. Date: May 15, 2014

(54) INFORMATION PROCESSING APPARATUS AND VERIFICATION METHOD

(71) Applicant: FUJITSU LIMITED, Kawasaki-shi (JP)

(72) Inventor: Yasushi ASANO, Toyohashi (JP)

(73) Assignee: FUJITSU LIMITED, Kawasaki-shi (JP)

(21) Appl. No.: 14/156,815

(22) Filed: Jan. 16, 2014

Related U.S. Application Data
(63) Continuation of application No. PCT/JP2011/067159, filed on Jul. 27, 2011.

(51) Int. Cl. G06F 13/30

(52) U.S. Cl. CPC G06F 13/30
USPC 710/26

(57) ABSTRACT

A verification method is executed by an information processing apparatus to verify priority control of transfer devices. The verification method includes: firstly generating pieces of data having different data amounts; secondly generating addresses in which a value is shifted; firstly associating the generated addresses in an ascending order of value of address with the generated pieces of data in a descending order of data amount; secondly associating device information indicating the transfer devices in a descending order of the degree of priority allocated to the transfer devices with the generated pieces of data in the descending order of data amount; instructing transfer of a generated piece of data to the address associated with the data, to the transfer device indicated by the device information associated with the data; and verifying the degree of priority according to a result of the transfer of the data.

### CROSS-REFERENCE TO RELATED APPLICATION(S)

This application is a continuation of International Application No. PCT/JP2011/067159, filed on Jul. 27, 2011, the entire contents of which are incorporated herein by reference.

### FIELD

The embodiments discussed herein are related to an information processing apparatus and a verification method.

### BACKGROUND

Previously, a transfer device including a plurality of transfer channels to which different degrees of priority are respectively set is known. When data is allocated to each transfer channel, such a transfer device executes priority control of transferring the data allocated to each transfer channel according to the order of the degrees of priority among the transfer channels.

Here, a technology is known, in which the transfer device connects a logic analyzer and the like to a signal line of each transfer channel and directly observes a waveform of a signal flowing in the signal line in order to verify whether the transfer device is accurately executing the priority control. However, the technology of directly observing a waveform of a signal needs alternation of the transfer device and the like in order to connect the logic analyzer to the signal line. Therefore, verification is burdensome.

Therefore, a verification program is known, which allocates a plurality of pieces of data to different transfer channels, respectively, and causes the transfer channels to transfer the data to the same storage region, to verify whether the transfer device has accurately executed the priority control. Hereinafter, as an example of such a verification program, a verification program of verifying a direct memory access (DMA) controller including a plurality of transfer channels will be described.

FIG. 19 is a diagram for describing an example of an information processing apparatus that executes a verification program. In the example illustrated in FIG. 19, an information processing apparatus 50 includes a central processing unit (CPU) 51, a random access memory (RAM) 52, and a DMA controller 53. In addition, the information processing apparatus 50 includes a bus 54 that connects the CPU 51, the RAM 52, and the DMA controller 53 one another.

The CPU 51 executes a verification program that verifies whether the DMA controller 53 accurately executes the priority control, and allocates data to a plurality of transfer channels included in the DMA controller 53. The DMA controller 53 includes a transfer channel #0 and a transfer channel #1 having a lower degree of priority than the transfer channel #0, and transfers the data allocated to the transfer channels #0 and #1 to the RAM 52.

FIG. 20 is a diagram for describing an operation of the verification program that verifies whether the priority control is being accurately performed. For example, the verification program allocates data #1 consisting only of “1” to the transfer channel #1, and allocates data #0 consisting only of “2” to the transfer channel #0. The verification program then instructs the DMA controller 53 to transfer the data #0 and the data #1 to a transfer data storage region 52a included in the RAM 52.

Then, the DMA controller 53 transfers the data #0 allocated to the transfer channel #0 having a higher degree of priority than the transfer channel #1 to the transfer data storage region 52a, and then transfers the data #1 allocated to the transfer channel #1 to the transfer data storage region 52a. That is, the DMA controller 53 overwrites the data #0 transferred to the transfer data storage region 52a with the data #1. Following that, the verification program verifies whether the DMA controller 53 has accurately executed the priority control by confirming that the data stored in the transfer data storage region 52a is only the data #1. As for an example of conventional technology, see Japanese Laid-open Patent Publication No. 63-289652, for example.

However, in the technology of transferring a plurality of pieces of data to the same storage region, the data allocated to another transfer channel is overwritten with the data allocated to the transfer channel having a lowest degree of priority. Therefore, there is a problem that whether data allocated to transfer channels other than the transfer channel having the lowest degree of priority has been lost is not determined.

In addition, in the technology of transferring a plurality of pieces of data to the same storage region, when the transfer device includes three or more transfer channels, whether the priority control of transfer channels other than the transfer channel having the highest degree of priority have been accurately performed is not determined. Hereinafter, the problem that the verification program does not determine whether the transfer device has accurately performed the propriety control when the transfer device includes three or more transfer channels will be described.

FIG. 21 is a diagram for describing an example of the problem in a conventional technology. In the example illustrated in FIG. 21, the DMA controller 53 includes the transfer channel #0, the transfer channel #1 having a lower degree of priority than the transfer channel #0, and a transfer channel #2 having a lower degree of priority than the transfer channel #1. When the data #0 to #2 are allocated to respective transfer channels, the DMA controller 53 finally transfers the data #2 allocated to the transfer channel #2 having the lowest degree of priority to the transfer data storage region 52a.

However, when only the data #2 is stored in the transfer data storage region 52a, the verification program does not determine whether either the data #0 or the data #1 has been first stored in the transfer data storage region 52a. As a result, the verification program does not verify whether the DMA controller 53 has accurately executed the priority control with respect to the transfer channels #0 and #1.

### SUMMARY

According to an aspect of an embodiment, a non-transitory computer-readable recording medium has stored therein a verification program executed by an information processing apparatus. The information processing apparatus is configured to verify priority control among a plurality of transfer devices. To the plurality of transfer devices, different degrees of priority are respectively allocated. The verification program causes the information processing apparatus to execute a process. The process includes: firstly generating a plurality of pieces of data having different data amounts; secondly generating a plurality of addresses in which a value is shifted; firstly associating the generated addresses in an ascending order of value of address with the plurality of generated pieces of data in a descending order of data amount; secondly associating device information indicating the transfer devices in a descending order of the degree of priority allocated to the transfer devices with the plurality of generated pieces of data in the descending order of data amount; instructing transfer of a generated piece of data to the address associated with the data, to the transfer device indicated by the device information associated with the data; and verifying the degree of priority among the plurality of transfer devices according to a result of the transfer of the data by the plurality of transfer devices.

According to another aspect of an embodiment, an information processing apparatus is configured to verify priority control among a plurality of transfer devices. To the plurality of transfer devices, different degrees of priority are respectively allocated. The information processing apparatus includes: a data generation unit configured to generate a plurality of pieces of data having different data amounts; an address generation unit configured to generate a plurality of addresses in which a value is shifted; an association unit configured to associate the addresses generated by the address generation unit in an ascending order of value of address with the plurality of pieces of data generated by the data generation unit in a descending order of data amount, and to associate device information indicating the transfer devices in a descending order of the degree of priority allocated to the transfer devices with the plurality of pieces of data generated by the data generation unit in a descending order of data amount; an instruction unit configured to instruct transfer of a piece of data generated by the data generation unit to the addresses associated with the data by the association unit, to the transfer device indicated by the device information associated with the data; and a verification unit configured to verify the degree of priority among the plurality of transfer devices according to a result of the transfer of the data by the plurality of transfer devices.

According to still another aspect of an embodiment, a verification method of a transfer device is executed by an information processing apparatus. The information processing apparatus is configured to verify priority control among a plurality of transfer devices. To the plurality of transfer devices, different degrees of priority are respectively allocated. The verification method includes: firstly generating a plurality of pieces of data having different data amounts; secondly generating a plurality of addresses in which a value is shifted; firstly associating the generated addresses in an ascending order of value of address with the plurality of generated pieces of data in a descending order of data amount; secondly associating device information indicating the transfer devices in a descending order of the degree of priority allocated to the transfer devices with the plurality of generated pieces of data in the descending order of data amount; instructing transfer of a generated piece of data to the address associated with the data, to the transfer device indicated by the device information associated with the data; and verifying the degree of priority among the plurality of transfer devices according to a result of the transfer of the data by the plurality of transfer devices.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for describing an example of an information processing apparatus according to a first embodiment;

FIG. 2 is a diagram for describing a DMA controller according to the first embodiment;

FIG. 3 is a diagram for describing an example of processing in which the DMA controller allocates Valid Channel when a rule of priority control is fixed;

FIG. 4 is a diagram for describing an example of processing in which the DMA controller allocates Valid Channel when the rule of the priority control is rotated;

FIG. 5 is a diagram for describing an example of operation mode information according to the first embodiment;

FIG. 6 is a diagram for describing an example of transfer information according to the first embodiment;

FIG. 7 is a diagram for describing an example of transmission data according to the first embodiment;

FIG. 8 is a diagram for describing an example of an error list according to the first embodiment;

FIG. 9A is a diagram for describing an example of a data list according to the first embodiment;

FIG. 9B is a first diagram for describing an example of processing executed by a transfer region allocation unit according to the first embodiment;

FIG. 9C is a second diagram for describing an example of processing executed by the transfer region allocation unit according to the first embodiment;

FIG. 10 is a diagram for describing an example of a channel number allocated by a channel allocation unit when the priority control is fixed;

FIG. 11 is a diagram for describing an example of a channel number allocated by the channel allocation unit when the priority control is rotated;

FIG. 12 is a diagram for describing an example of an expectation value;

FIG. 13 is a diagram for describing an example of a descriptor;

FIG. 14 is a diagram for describing an example of data stored in a reception region when the priority control has not been accurately executed;

FIG. 15 is a diagram for describing an example of processing in which the DMA controller transmits data according to the descriptor;

FIG. 16 is a diagram for describing an example of data stored in the reception region;

FIG. 17 is a diagram for describing correspondence between the data, the descriptor, and the reception region;

FIG. 18 is a flowchart for describing an example of a flow of processing executed by the information processing apparatus according to the first embodiment;

FIG. 19 is a diagram for describing an example of the information processing apparatus that executes a verification program;

FIG. 20 is a diagram for describing an operation of the verification program that verifies whether the priority control has been accurately performed; and

FIG. 21 is a diagram for describing an example of a problem in a previous technology.

### DESCRIPTION OF EMBODIMENT(S)

Preferred embodiments of the present invention will be explained with reference to accompanying drawings.

### [a] First Embodiment

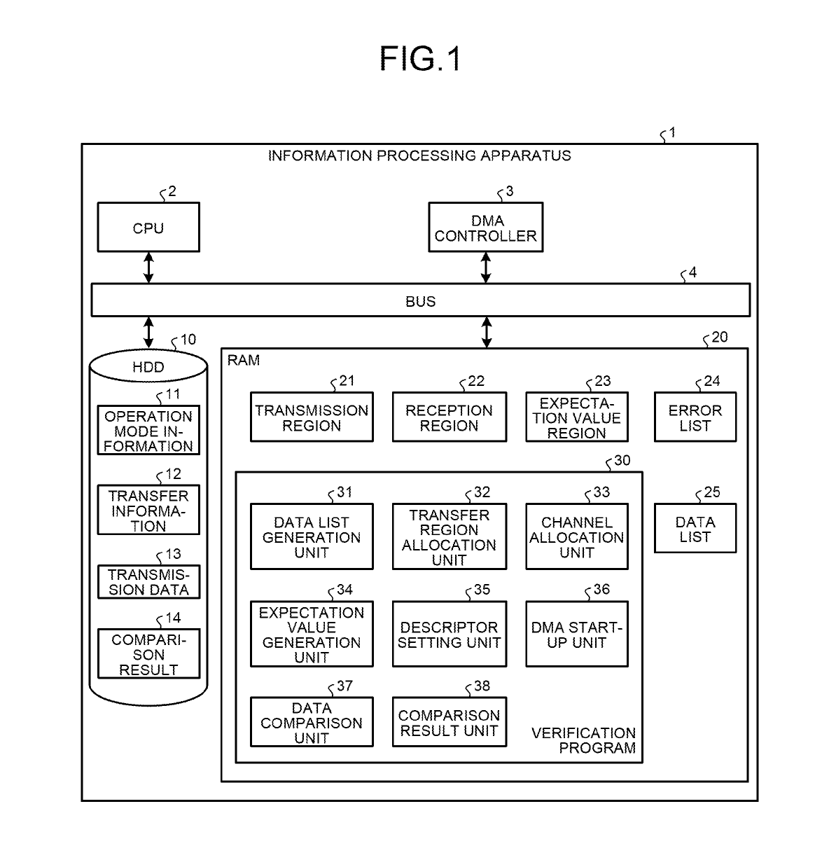

In the following, an example of an information processing apparatus according to a first embodiment will be described using FIG. 1. FIG. 1 is a diagram for describing an example of an information processing apparatus according to the first embodiment.

As illustrated in FIG. 1, an information processing apparatus 1 includes a central processing unit (CPU) 2, a direct memory access (DMA) controller 3, a hard disk drive (HDD) 10, and a random access memory (RAM) 20. Further, the information processing apparatus 1 includes a bus 4 that connects the CPU 2, the HDD 10, and the RAM 20 one another.

The HDD 10 stores operation mode information 11, transfer information 12, transmission data 13, and a comparison result 14. Further, the RAM 20 includes a transmission region 21, a reception region 22, and an expectation value region 23, and stores an error list 24, a data list 25, and a verification program 30. Further, the verification program 30 includes a data list generation unit 31, a transfer region allocation unit 32, a channel allocation unit 33, an expectation value generation unit 34, a descriptor setting unit 35, a DMA start-up unit 36, a data comparison unit 37, and a comparison result unit 38.

The CPU 2 is an arithmetic processor that reads out the verification program 30 stored in the RAM 20, and executes processing of the units 31 to 38 included in the verification program 30. To be specific, the CPU 2 reads out the verification program 30 from the RAM 20, and sequentially executes functions of the units 31 to 38 included in the verification program 30. By execution of such a verification program 30, the CPU 2 generates the data list 25 used for transfer of data by the DMA controller 3.

In addition, the CPU 2 generates a result obtained when the DMA controller 3 normally executes the priority control as an expectation value, and stores the expectation value in the expectation value region 23. Following that, the CPU 2 executes start-up processing of the DMA controller 3, and transfers the data stored in the transmission region 21 to the reception region 22 according to the data list 25. In addition, the CPU 2 determines whether the data transferred to the reception region 22 by the DMA controller 3 and the expectation value stored in the expectation value region 23 coincide with each other. Then, when having determined that the data transferred to the reception region 22 by the DMA controller 3 and the expectation value stored in the expectation value region 23 coincide with each other, the CPU 2 determines that the DMA controller 3 has accurately executed the priority processing.

The DMA controller 3 transfers information stored in the RAM 20 without through the CPU 2. To be specific, the DMA controller 3 transfers the data in the transmission region 21 to the reception region 22 according to a descriptor generated by execution of the verification program 30 by the CPU 2. Hereinafter, the DMA controller 3 will be described in detail using the drawings.

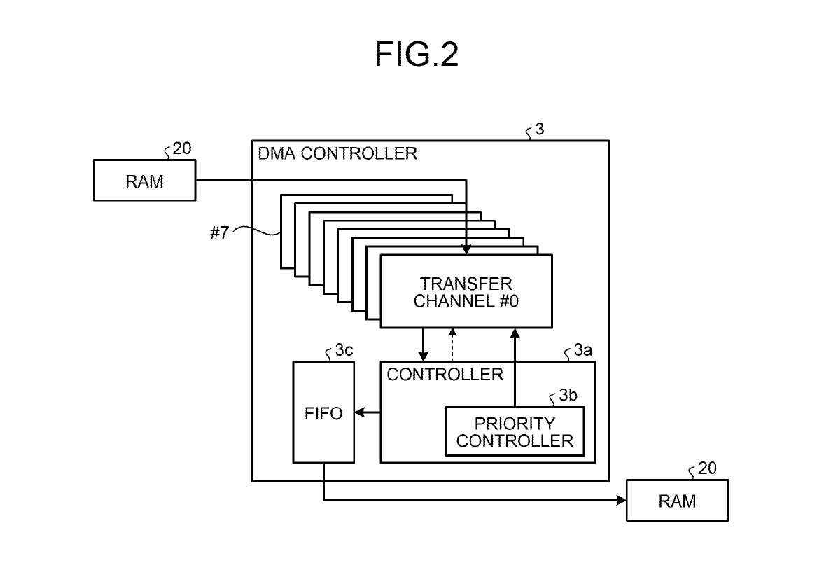

FIG. 2 is a diagram for describing the DMA controller according to the first embodiment. In the example illustrated in FIG. 2, the DMA controller 3 includes a plurality of transfer channels #0 to #7, a controller 3a, and a fast in fast out (FIFO) 3c. When receiving a designation of data based on the descriptor from the controller 3a, each of the transfer channels #0 to #7 outputs Read Address Valid that is a read request of the designated data to the controller 3a.

When Valid Channel is allocated by a priority controller 3b included in the controller 3a, each of the transfer channels #0 to #7 then acquires the data from the transmission region 21 included in the RAM 20, and transmits the acquired data to the controller 3a. In addition, when Valid Channel is allocated, each of the transfer channels #0 to #7 terminates the output of Read Address Valid.

When the start-up processing of the DMA controller 3 is executed, the controller 3a acquires the descriptor stored in the RAM 20, and transmits designation of data to be acquired to the transfer channels #0 to #7 based on the acquired descriptor. Further, when receiving the data from the transfer channels #0 to #7, the controller 3a transmits the data received at a transmission destination indicated by the descriptor in the reception region 22 to a FIFO 3c.

The priority controller 3b executes the priority control of the transfer channels #0 to #7. To be specific, the priority controller 3b determines a transfer channel that is outputting Read Address Valid from among the transfer channels #0 to #7 at predetermined time intervals.

When a rule of the priority control is “rotated”, the priority controller 3b allocates, from the determined transfer channels, Valid Channel to a transfer channel having a next number of the transfer channel to which Valid Channel was previously allocated. That is, the priority controller 3b determines a transfer channel having the highest degree of priority from among the transfer channels #0 to #7 by a round robin system.

Further, when the rule of the priority control is “fixed”, the priority controller 3b selects a transfer channel having the smallest number from among the determined transfer channels, and allocates Valid Channel to the selected transfer channel. That is, the priority controller 3b considers the transfer channel #0 as a transfer channel having the highest degree of priority, and determines a transfer channel having a lower degree of priority as the number increases.

Note that the priority controller 3b can set the degree of priority to the transfer channels #0 to #7 in an arbitrary order. That is, the priority controller 3b can allocate the degree of priority to the transfer channels #0 to #7 depending on hardware. In addition, the priority controller 3b notifies that the rule of the priority control is fixed or rotated when receiving a notification request of the rule of the priority control from the CPU 2. In addition, the priority controller 3b notifies the degrees of priority allocated to the transfer channels #0 to #7.

The FIFO 3c stores the data in the order of receiving the data from the controller 3a, and transmits the data to the RAM 20 in the order from data received earlier. That is, the FIFO 3c receives the data designated to the transfer channels #0 to #7 in the order according to the degrees of priority of the transfer channels #0 to #7, and transmits the received data to the RAM 20 in the order of receiving the data.

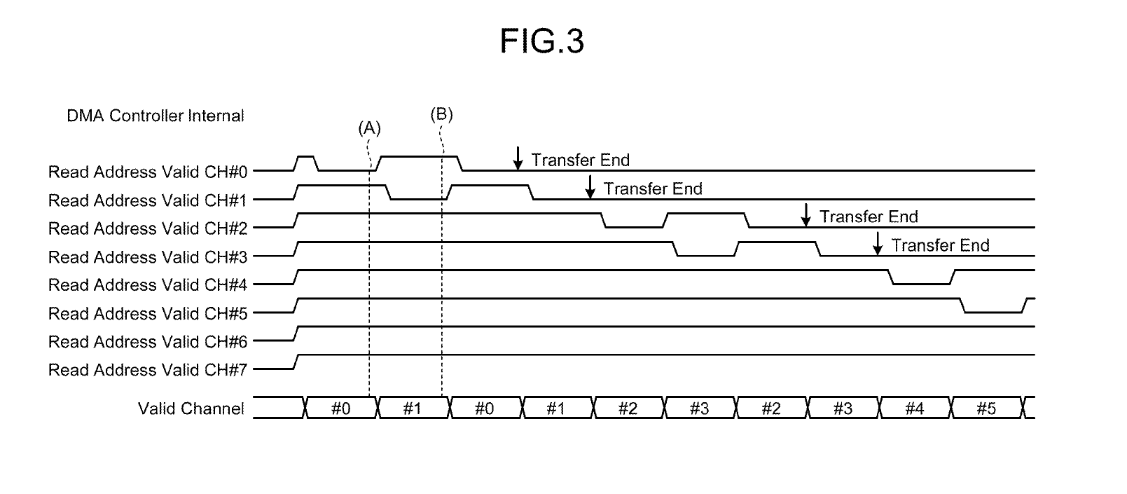

Next, an example of processing in which the DMA controller 3 allocates Valid Channel to the transfer channels #0 to #7 will be described using the drawings. First, an example of processing in which the DMA controller 3 allocates Valid Channel to the transfer channels #0 to #7 when the rule of the priority control is fixed will be described using FIG. 3.

FIG. 3 is a diagram for describing an example of processing in which the DMA controller allocates Valid Channel when the rule of the priority control is fixed. The example in FIG. 3 illustrates Read Address Valid signals output from the transfer channels #0 to #7 and Valid Channel allocated by the DMA controller 3.

Note that the example in FIG. 3 illustrates the Read Address Valid signals output from the transfer channels #0 to #7 as Read Address Valids CH#0 to CH#7. Note that FIG. 3 illustrates an example in which each of the transfer channels #0 to #7 transmits two pieces of data. In addition, in the example illustrated in FIG. 3, a transfer channel having a smaller number has a higher degree of priority. That is, the transfer channel #0 has the highest degree of priority, and the transfer channel #7 has the lowest degree of priority.

For example, in the example illustrated in FIG. 3, Read Address Valids CH#0 to #7 output from the transfer channels #0 to #7 become “High” at the same time. In such a case, the DMA controller 3 allocates Valid Channel to the transfer channel #0. Therefore, Read Address Valid CH#0 output from the transfer channel #0 becomes “Low”.

Next, the DMA controller 3 confirms Read Address Valids CH#0 to CH#7 at a timing when a predetermined time has passed since the allocation of Valid Channel to the transfer channel #0, as illustrated by (A) in FIG. 3. In the example illustrated by (A) in FIG. 3, Read Address Valids CH#1 to CH#7 among Read Address Valids CH#0 to #7 are “High”. Therefore, the DMA controller 3 allocates Valid Channel to the transfer channel #1 having the smallest number, that is, the transfer channel #1 having the highest degree of priority among the transfer channels #1 to #7.

Here, after Valid Channel is allocated to the transfer channel #1, the transfer channel #0 terminates the transmission of the first data, and causes Read Address Valid CH#0 to be “High” in order to transmit the second data. Therefore, in (B) in FIG. 3, Read Address Valids CH#0, CH#2 to CH#7 are “High”. Thus, the DMA controller 3 allocates Valid Channel to the transfer channel #0 having the smallest number.

Following that, the transfer channel #0 terminates the transfer of the data, and keeps Read Address Valid CH#0 “Low”. Other transfer channels #1 to #7 after receiving the allocation of Valid Channel and transferring two pieces of data, keep Read Address Valid “Low”.

By execution of such processing, in the example illustrated in FIG. 3, the DMA controller 3 allocates Valid Channel in the order of the transfer channels “#0”, “#1”, “#0”, “#1”, “#2”, “#3”, “#2”, “#3”, “#4”, “#5”, and the like. That is, when the rule of the priority control is fixed, the DMA controller 3 alternately allocates Valid Channel to the transfer channels #0 to #7 by the number of pieces data to be transmitted. In other words, when the rule of the priority control is fixed, the DMA controller 3 allocates Valid Channel to the transfer channels #0 to #7 by the number of pieces of data to be transmitted in a zigzag manner.

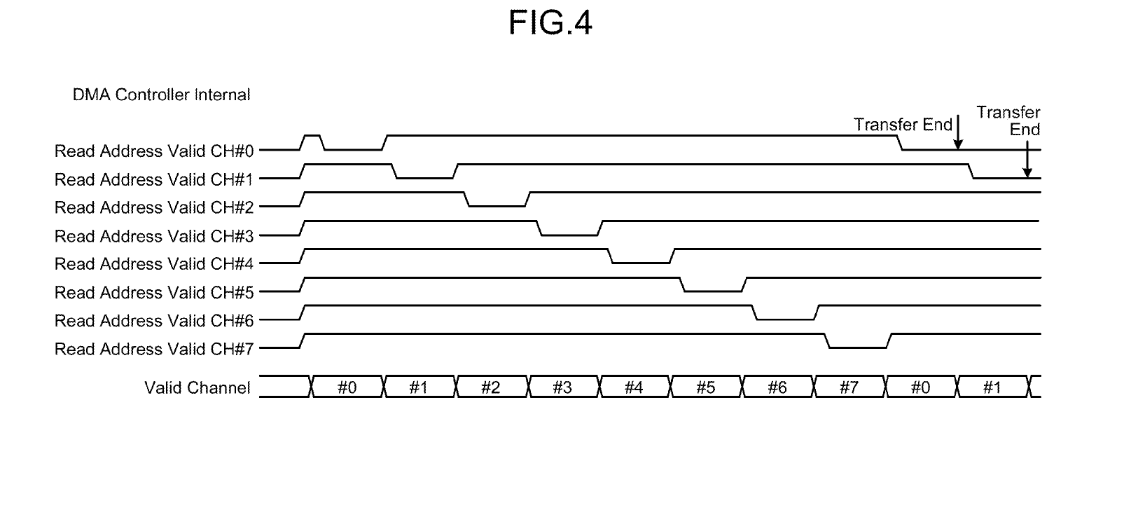

Next, an example of processing in which the DMA controller 3 allocates Valid Channel to the transfer channels #0 to #7 when the rule of the priority control is rotated will be described using FIG. 4. FIG. 4 is a diagram for describing an example of processing in which the DMA controller allocates Valid Channel when the rule of the priority control is rotated.

Note that the example in FIG. 4 illustrates, similarly to FIG. 3, Read Address Valid signals output from the transfer channels #0 to #7 and Valid Channel allocated by the DMA controller 3. Further, the example in FIG. 4 illustrates, similarly to FIG. 3, an example in which each of the transfer channels #0 to #7 transmits two pieces of data.

For example, in the example illustrated in FIG. 4, Read Address Valids CH#0 to CH#7 output from the transfer channels #0 to #7 become “High” at the same time. In such a case, the DMA controller 3 allocates Valid Channel to the transfer channel #0.

Next, the DMA controller 3 confirms the Read Address Valids CH#0 to CH#7 at a timing when a predetermined time has passed since the allocation of Valid Channel to the transfer channel #0. In the example illustrated in FIG. 4, Read Address Valids CH#1 to CH#7 among Read Address Valids CH#0 to CH#7 are “High”. Therefore, the DMA controller 3 allocates Valid Channel to the transfer channel #1 having the next smallest number of the transfer channel #0 to which Valid Channel has been previously allocated.

Here, after Valid Channel is allocated to the transfer channel #1, the transfer channel #0 terminates the transmission of the first data, and causes Read Address Valid CH #0 to be “High” in order to transmit the second data. However, since the rule of the priority control is rotated, the transfer channel #2 has the highest degree of priority after the allocation of Valid Channel to the transfer channel #1. Therefore, the DMA controller 3 allocates Valid Channel to the transfer channel #2 having the highest degree of priority among the transfer channels #0, and #2 to #7.

By execution of such processing, the DMA controller 3 allocates Valid Channel in the order of the transfer channels “#0”, “#1”, “#2”, “#3”, “#4”, “#5”, “#6”, “#7”, “#0”, “#1” and the like in the example illustrated in FIG. 3. That is, when the rule of the priority control is rotated, the DMA controller 3 repeatedly performs the processing of sequentially allocating Valid Channel to the transfer channels #0 to #7 until each of the transfer channels #0 to #7 transmits two pieces of data.

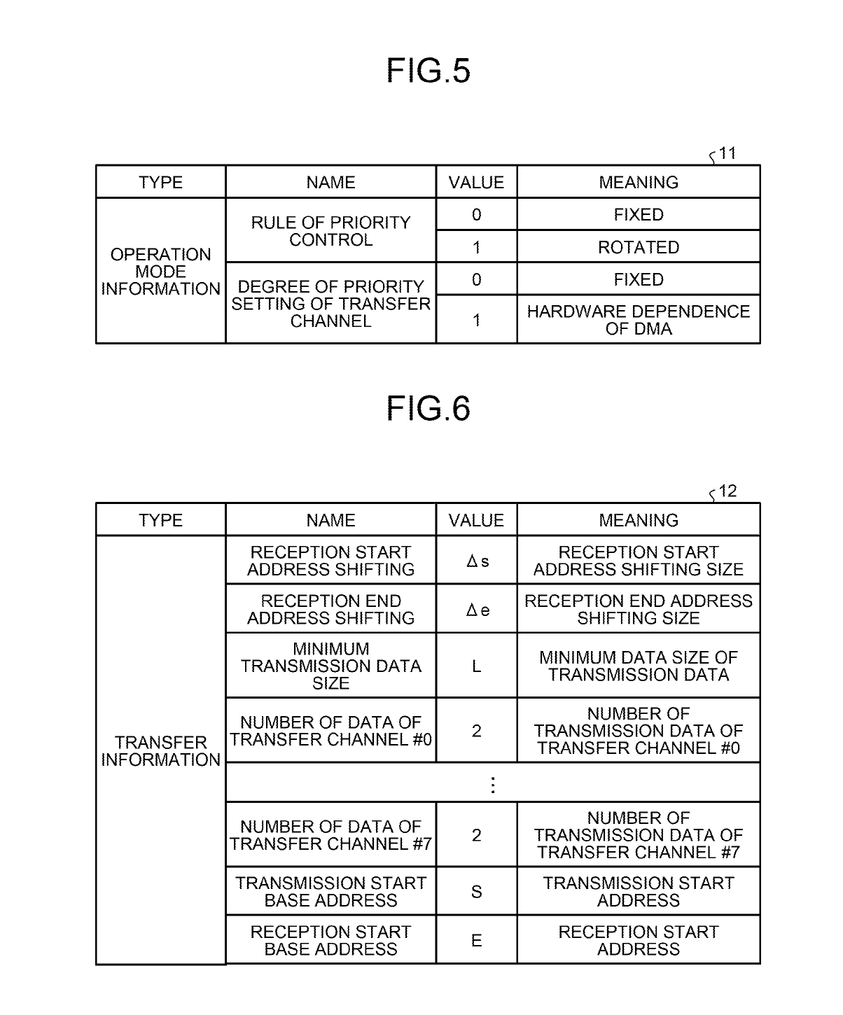

Next, referring back to FIG. 1, information stored in the HDD 10 will be described. The operation mode information 11 is information indicating the content of the priority control executed by the DMA controller 3. Hereinafter, an example of the operation mode information 11 will be described using FIG. 5.

FIG. 5 is a diagram for describing an example of operation mode information according to the first embodiment. In the example illustrated in FIG. 5, a value indicating the rule of the priority control and a value indicating priority setting of the transfer channels are stored in the operation mode information 11. That is, when “0” is stored as the rule of the priority control, the operation mode information 11 indicates that the content of the priority control in the DMA controller 3 is fixed. Further, when “1” is stored as the rule of the priority control, the operation mode information 11 indicates that the content of the priority control in the DMA controller 3 is rotated.

Further, when the value of the degree of priority setting of transfer channel is “0”, the operation mode information 11 indicates that a transfer channel having a smaller number has a higher degree of priority. On the other hand, when the value of the priority setting of transfer channel is “1”, the operation mode information 11 indicates that the degree of priority depends on the DMA controller 3.

Referring back to FIG. 1, the transfer information 12 is information indicating a destination of data to be transmitted by the DMA controller 3, the content of the data, and the number of data transferred by the transfer channels #0 to #7. Hereinafter, an example of the transfer information 12 will be described using FIG. 6.

FIG. 6 is a diagram for describing an example of the transfer information according to the first embodiment. In the example illustrated in FIG. 6, a numerical value of reception start address shifting, a numerical value of reception end address shifting, a numerical value of a minimum transmission data size, and the number of data transferred by the transfer channels #0 to #7 are stored in the transfer information 12.

Here, the reception start address shifting is an amount of shifting of a memory address that is a storage destination of data transferred by the DMA controller 3. As described below, when having normally executed the priority control, the DMA controller 3 transfers the data having different sizes in the descending order from larger data while shifting the memory address that is the destination.

That is, the reception start address shifting means the amount of shifting of the memory address that is the destination by the DMA controller 3. Further, the reception end address shifting indicates a size of shifting of a reception end address of a memory address that is a destination when the DMA controller 3 transfers data. Further, the minimum transmission data size indicates a smallest data amount of data among the data to be transmitted by the DMA controller 3. The number of data to be transmitted by the transfer channels #0 to #7 is the number of pieces of data to be transmitted by the transfer channels #0 to #7.

Note that, in the example illustrated in FIG. 6, a numerical value of the reception start address shifting “Δs”, a numerical value of the reception end address shifting “Δe”, a numerical value of the minimum transmission data size “L”, and the number of the data to be transferred by the transfer channels #0 to #7 “2” are stored in the transfer information 12.

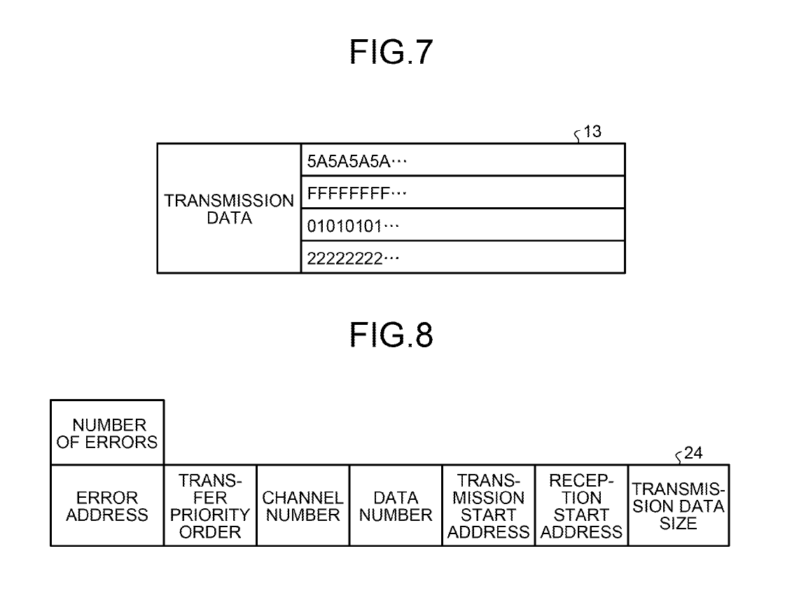

Referring back to FIG. 1, transmission data 13 is data to be transmitted by the DMA controller 3. Here, an example of the transmission data 13 will be described using FIG. 7. Note that FIG. 7 is a diagram for describing an example of the transmission data according to the first embodiment. For example, as illustrated in FIG. 7, the HDD 10 stores data in which the content is “5A5A5A . . . ”, data in which the content is “FFFFFF . . . ”, data in which the content is “010101 . . . ”, and data in which the content is “222222 . . . ” as the transmission data 13.

Referring back to FIG. 1, the comparison result 14 stores a result of evaluation performed by the verification program 30 described below. To be specific, in the comparison result 14, the data stored in the data list 25, the error list 24, and the reception region 22, and the data stored in the expectation value region 23 after the evaluation is executed by the DMA controller 3 according to the verification program 30 are stored.

Next, the transmission region 21, the reception region 22, the expectation value region 23, the error list 24, and the data list 25 included in the RAM 20 will be described. The transmission region 21 is a region in which the data to be transferred by the DMA controller 3 to the reception region 22 is stored. The reception region 22 is a region in which the data transferred by the DMA controller 3 from the reception region 22 is stored. The expectation value region 23 is a region in which expectation to be generated by the verification program 30 is stored. Here, the expectation value is data stored in the reception region 22 when the DMA controller 3 has accurately executed the priority control of the transfer channels #0 to #7.

The error list 24 is a list in which an error address indicating an address, in which the data that do not coincide with each other are stored, of the data stored in the reception region 22 and the data stored in the expectation value region 23. Hereinafter, an example of the error list 24 will be described using FIG. 8. FIG. 8 is a diagram for describing an example of the error list 24 according to the first embodiment. In the example illustrated in FIG. 8, an error address, a transfer priority order, a transfer channel number, a data number, a transmission start address, a reception start address, and a transmission data size are stored in the error list 24.

The data list 25 is a list generated by the verification program 30, and is information indicating the data to be transferred by the transfer channels #0 to #7 of the DMA controller 3 and the order of transmission of data by the transfer channels #0 to #7.

Next, units 31 to 38 included in the verification program 30 will be described. Note that the units 31 to 38 included in the verification program 30 exert its functions by being executed by the CPU 2.

The data list generation unit 31 generates the data list 25. To be specific, the data list generation unit 31 refers to the transfer information 12 stored in the HDD 10, and reads out the number of data to be transferred by the transmission channel #0 to #7. In addition, the data list generation unit 31 calculates the total number of data to be transferred by the transfer channels #0 to #7 (hereinafter, described as Pt). The data list generation unit 31 then generates the data list 25 in which calculated Pt data is to be stored in a secured region.

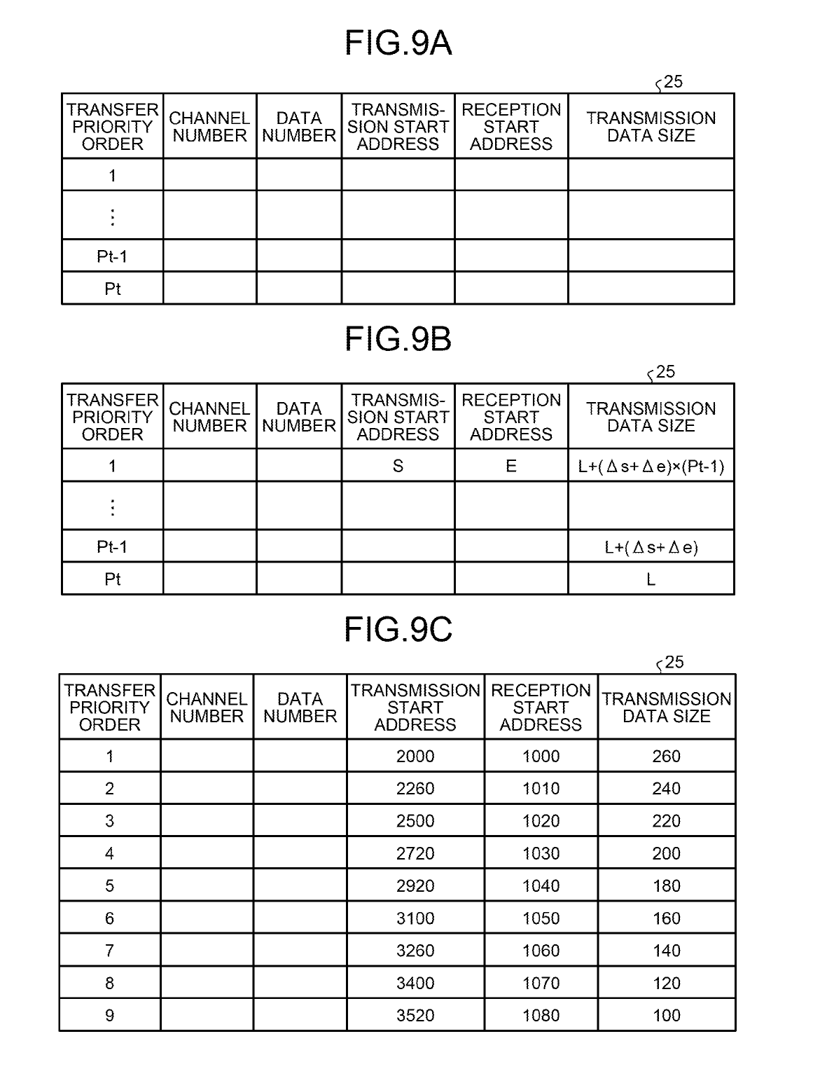

Hereinafter, an example of the data list 25 generated by the data list generation unit 31 will be described using the drawings. FIG. 9A is a diagram for describing an example of the data list according to the first embodiment. In the example illustrated in FIG. 9A, the data list generation unit 31 generates a list in which information indicating a transfer priority order, a channel number, a data number, a transmission start address, a reception start address, and a transmission data size is stored, regarding the Pt data.

Here, the transfer priority order is a number indicating an order of transfer by the DMA controller 3. Further, the channel number is information indicating to which transfer channel data is allocated among the transfer channels #0 to #7 included in the DMA controller 3, that is, a number indicating the transfer channels #0 to #7. The data number is a number indicating in which order data is transferred in the transfer channel to which the data is allocated. The transmission start address is an address indicating a head of a region in which data is stored in the transmission region 21.

Further, the reception start address is an address indicating a head position of a region in which data transferred by the DMA controller 3 is stored in the reception region 22. The transmission data size indicates the size of data.

Referring back to FIG. 1, the transfer region allocation unit 32 refers to the transfer information 12 stored in the HDD 10, and generates a plurality of pieces of data having different data amounts and a plurality of addresses in which a value is shifted, based on the referred transfer information 12. The transfer region allocation unit 32 then associates the generated address with the generated data such that an address having a smaller value is allocated to data having a larger data amount. That is, the transfer region allocation unit 32 associates the generated address in the ascending order of address value with the generated data in the descending order of data amount.

Hereinafter, an example of processing executed by the transfer region allocation unit 32 will be described using FIG. 9B. FIG. 9B is a first diagram for describing an example of processing executed by the transfer region allocation unit according to the first embodiment. First, the transfer region allocation unit 32 refers to the transfer information 12, and reads out a minimum transmission data size “L”, a value of the reception start address shifting “Δs”, a value of the reception end address shifting “Δe”, a transmission start base address “S”, and a reception start base address “E”.

The transfer region allocation unit 32 then sets the transmission start address, the reception start address, and the transmission data size regarding the data having the transfer priority orders of “1” to “Pt” in the data list 25. To be specific, the transfer region allocation unit 32 stores the minimum transmission data size “L” in the transmission data size regarding the data having the transfer priority order of “Pt”. That is, the transfer region allocation unit 32 allocates data having the smallest data amount from among data to be transmitted to data having the lowest priority order.

Next, the transfer region allocation unit 32 stores, regarding the data having the priority order of “Pt-1”, a value obtained by adding “Δs+Δe” to the transmission data size of the data having the priority order of “Pt”. Further, the transfer region allocation unit 32 stores, regarding the data having the priority order of “Pt-2”, a value obtained by adding “Δs+Δe” to the transmission data size of the data having the transfer priority order of “Pt-1”. That is, the transfer region allocation unit 32 allocates a value represented by “L+(Δs+Δe)×(Pt−n)” as the transmission data size of data having the transmission priority order of “n”. That is, the transfer region allocation unit 32 sets the data list 25 such that data having a larger data amount is preferentially transmitted.

Following that, the transfer region allocation unit 32 stores the transmission start base address “S” in the transmission start address of the data having the transfer priority order 1, and the reception start base address “E” in the reception start address of the data having the transfer priority order 1. Next, the transfer region allocation unit 32 stores “S+L+(Δs+Δe)×(Pt−1)” in the transmission start address of the data having the transfer priority order 2, and stores “E+Δs” in the reception start address.

That is, the transfer region allocation unit 32 stores, in the transmission start address of data having the transfer priority order of “n”, a value obtained by adding “L+(Δs+Δe)×(Pt−n+1)” to the transmission start address of data having the transfer priority order of “n−1”. Further, the transfer region allocation unit 32 stores “E+Δe×(n−1)” in the reception start address of the data having the transfer priority order of “n”.

Further, the transfer region allocation unit 32 secures the transmission region 21 for storing the data having the transfer priority orders of “1” to “Pt”, and the reception region 22 for storing the data transferred by the DMA controller 3. In addition, the transfer region allocation unit 32 secures the expectation value region 23 for storing an expectation value.

To be specific, the transfer region allocation unit 32 calculates “L×Pt+(Δs+Δe)×Pt×(Pt−1)/2”, and secures a region having the calculated size from the RAM 20 as the transmission region 21. Further, the transfer region allocation unit 32 calculates “L+(Δs+Δe)×(Pt−1)”, and secures a region having the calculated size from the RAM 20 as the reception region 22. Further, the transfer region allocation unit 32 secures a region having the same size as the reception region 22 from the RAM 20 as the expectation value region 23. In addition, the transfer region allocation unit 32 has a head address of the transmission region 21 as “S”, and a head address of the reception region 22 as “E”.

Further, the transfer region allocation unit 32 reads out the transmission data 13 from the HDD 10, and stores the read out data in the secured transmission region 21. That is, the transfer region allocation unit 32 creates a plurality of pieces of data having different data amounts in incremental steps, and stores the created data in the transmission region 21.

Here, an example of a value set by the transfer region allocation unit 32 to the data list 25 will be described using FIG. 9C. FIG. 9C is a second diagram for describing an example of processing executed by the transfer region allocation unit 32 according to the first embodiment. Note that the example in FIG. 9C illustrates an example of the data list 25 when “Pt=9”.

For example, the transfer region allocation unit 32 reads out a minimum transmission data size “100”, a value of the reception start address shifting “10”, a value of the reception end address shifting “10”, a transmission start base address “2000”, and a reception start base address “1000”.

The transfer region allocation unit 32 then stores, as illustrated in FIG. 9C, the transmission data sizes “260”, “240”, “220”, “200”, “180”, “160”, “140”, “120”, and “100” from the data having the transfer priority order 1. Further, the transfer region allocation unit 32 stores the transmission start addresses “2000”, “2260”, “2500”, “2720”, “2920”, “3100”, “3260”, “3400”, and “3520” from the data having the transfer priority order 1. Further, the transfer region allocation unit 32 stores the reception start addresses “1000”, “1010”, “1020”, “1030”, “1040”, “1050”, “1060”, “1070”, and “1080” from the data having the transfer priority order 1.

Referring back to FIG. 1, the channel allocation unit 33 allocates the data to the transfer channels #0 to #7 included in the DMA controller 3 such that data having a higher transfer priority order is preferentially transferred. That is, the channel allocation unit 33 associates channel numbers indicating transfer channels having higher degrees of priority allocated thereto with data in the descending order from data having a larger data amount. To be specific, the channel allocation unit 33 associates channel numbers in the descending order of the degree of priority of the transfer channels #0 to #7 with data in the descending order from the data having the largest data amount, according to the rule of the priority control executed by the DMA controller 3.

To be specific, when the rule of the priority control executed by the DMA controller 3 is rotated, the channel allocation unit 33 executes following processing. That is, the channel allocation unit 33 associates channel numbers to data in the descending order of data amount from data having the largest data amount, according to the degrees of priority allocated to the transfer channels #0 to #7. That is, when the degree of priority is allocated in the descending order of the degree of priority from the transfer channel #0 to the transfer channel #7, the channel allocation unit 33 associates the channel numbers as flows.

That is, the channel allocation unit 33 stores the channel numbers “1”, “2”, “3”, “4”, “5”, “6”, and “7” in the data list 25 in the descending order of data amount from data having the largest data amount. Further, the channel allocation unit 33 repeatedly stores the channel numbers “1”, “2”, “3”, “4”, “5”, “6”, and “7” again in the descending order from data having a larger data amount with respect to data to which a channel number has not been allocated. Further, the channel allocation unit 33 associates data numbers with data in the descending order from data having a larger data amount, regarding data to which the same channel number is associated.

Further, when the rule of the priority control executed by the DMA controller 3 is fixed, the channel allocation unit 33 executes following processing. That is, the channel allocation unit 33 determines the number of pieces of data to be transferred by the transfer channels #0 to #7. When there is not a transfer channel that transits a plurality of pieces of data, the channel allocation unit 33 associates channel numbers in the descending order from a channel number of a transfer channel having a higher degree of priority with data in the descending order from data having the largest data amount.

When there is a channel that transmits a plurality of pieces of data, the channel allocation unit 33 executes following processing. That is, the channel allocation unit 33 associates a channel number of a transfer channel having the highest degree of priority with data having the largest data amount among data not associated with any channel number. Further, when there is a plurality of pieces of data to be transmitted from any transfer channel, the channel allocation unit 33 executes following processing regarding each channel number in the order of the degree of priority allocated to the transfer channels #0 to #7 from a channel number indicating a transfer channel having the highest degree of priority.

That is, the channel allocation unit 33 associates a channel number indicating a transfer channel having the highest degree of priority among channel numbers not associated with any data with data having the largest data amount among data not associated with any channel number. Further, the channel allocation unit 33 alternately associates a channel number, which is the same as the channel number associated with the data, with data in the descending order from data having a larger data amount among data associated with the channel number, by the number of pieces of data to be transmitted by the transfer channel.

That is, when the degree of priority from the transfer channel #0 to the transfer channel #7 becomes low in that order, and each transfer channel transmits two pieces of data, the channel allocation unit 33 associates following channel numbers with the data. That is, the channel allocation unit 33 associates “0”, “1”, “0”, “1”, “2”, “3”, “2”, “3”, “4”, “5”, “4”, “5”, “6”, “7”, “6”, and “7” with data in the descending order of data amount. Further, the channel allocation unit 33 associates, regarding data associated with the same channel number, data numbers with data in the descending order from data having a larger data amount.

Hereinafter, detailed processing executed by the channel allocation unit 33 will be described. First, the channel allocation unit 33 refers to the operation mode information 11, and identifies the rule of the priority control of the DMA controller 3 and the priority setting of transfer channel. When the priority setting of transfer channel is “0”, the channel allocation unit 33 determines a small number has a higher degree of priority with respect to the transfer channels #0 to #7. Further, when the priority setting of transfer channel is “1”, the channel allocation unit 33 acquires the degrees of priority allocated to the transfer channels #0 to #7 from the DMA controller 3.

Further, when the rule of the priority control is “0”, the channel allocation unit 33 determines that the priority control in the DMA controller 3 is fixed. Further, when the rule of the priority control is “1”, the channel allocation unit 33 determines that the priority control in the DMA controller 3 is rotated.

Further, when having determined that the rule of the priority control is fixed, the channel allocation unit 33 executes following processing in the descending order of the degree of priority allocated to the transfer channels #0 to #7. First, the channel allocation unit 33 selects a channel number indicating a transfer channel having the highest degree of priority from among channel numbers not allocated to data. The channel allocation unit 33 then searches the data list 25 for data having the highest transfer priority order among data to which a channel number has not been allocated. The channel allocation unit 33 then stores the selected channel number in the channel number regarding the searched data, and executes processing of allocating a channel number having the next highest degree of priority when there is only one piece of data to be transmitted by the transfer channel of the selected channel number.

Meanwhile, when there is plurality of pieces of data to be transmitted by the transfer channel of the selected channel number, the channel allocation unit 33 executes following processing. First, the channel allocation unit 33 determines the number of allocation of the selected channel number, that is, the number of pieces of data “Pi” to be transmitted by the transfer channel of the selected channel number. Further, the channel allocation unit 33 determines the value “Pu” obtained by subtracting the number of pieces of data to which a channel number has already been allocated and the number of pieces of data to be transmitted by the transfer channel regarding the channel number in allocation, from the number of all pieces of data.

When “Pu=0”, the channel allocation unit 33 allocates the selected channel number and a data number to data to which a channel number has not been allocated in the descending order of data amount. When “Pi” is larger than “Pu”, the channel allocation unit 33 executes following processing. That is, the channel allocation unit 33 allocates the selected channel number and the data number to every two pieces of data in the descending order of data amount among data to which a channel number has not been allocated.

Further, when having determined that the rule of the priority control is rotated, the channel allocation unit 33 allocates channel numbers in the order of the degree of priority allocated to the transfer channels #0 to #7 to data to which a channel number has not been allocated in the descending order of data amount. Further, the channel allocation unit 33 allocates channel numbers in the order of the degree of priority allocated to the transfer channels #0 to #7 to all pieces of data in the descending order of data amount until the channel numbers are allocated to all pieces of data.

With execution of such processing, the channel allocation unit 33 can set the data list 25 to be transferred in the descending order of data among the generated data. Note that, even in a case where the priority control in the DMA controller 3 is special, the channel allocation unit 33 can set the data list 25 to be transferred in the descending order of data amount. For example, when the DMA controller 3 includes a plurality of transfer channels, the channel allocation unit 33 determines in which order the data is transmitted among the transfer channels. Then, the channel allocation unit 33 just allocates a channel number to data in the descending order from data having a larger data amount according to the determined order.

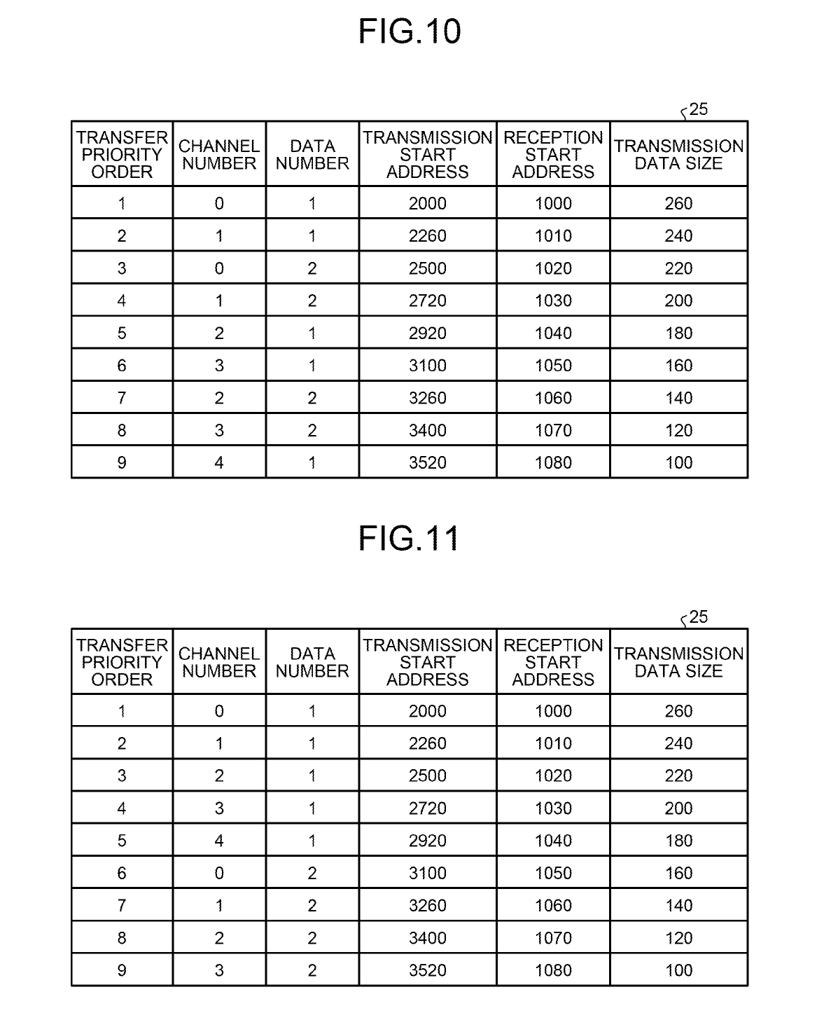

Next, an example of a channel number allocated by the channel allocation unit 33 will be described using FIGS. 10 and 11. First, a channel number allocated by the channel allocation unit 33 when the priority control is fixed will be described using FIG. 10. FIG. 10 is a diagram for describing an example of a channel number allocated by the channel allocation unit when the priority control is fixed.

Note that, in the example illustrated in FIG. 10, the DMA controller 3 includes five transfer channels #0 to #4, and the degree of priority becomes higher in the order of the transfer channel #4, the transfer channel #3, the transfer channel #2, the transfer channel #1, and the transfer channel #0. Further, in the example illustrated in FIG. 10, each of the transfer channels #0 to #3 transfers two pieces of data and the transfer channel #4 transfers one piece of data.

In such a case, the channel allocation unit 33 execute the above-described processing with respect to the channel number “0”. That is, as illustrated in FIG. 10, the channel allocation unit 33 allocates the channel number “0” and the data number “1” to data having the transfer priority order 1, which has the largest data amount. The channel allocation unit 33 allocates the channel number “0” and the data number “2” to data having the transfer order 3 which skips one data from the data having the transfer priority order 1.

Next, the channel allocation unit 33 executes the above-described processing with respect to the channel number “1”, allocates the channel number “1” and the data number “1” to data having the transfer priority order 2, and the channel number “1” and the data number “2” to data having the transfer priority order 4, as illustrated in FIG. 10. Next, the channel allocation unit 33 executes the above-described processing with respect to the channel number “2”, and allocates the channel number “2” and the data number “1” to data having the transfer priority order 5, and the channel number “2” and the data number “2” to data having the transfer priority order 7, as illustrated in FIG. 10.

Next, the channel allocation unit 33 executes the above-described processing with respect to the channel number “3”, and allocates the channel number “3” and the data number “1” to data having the transfer priority order 6, and the channel number “3” and the data number “2” to data having the transfer priority order 8, as illustrated in FIG. 10. Next, the channel allocation unit 33 executes the above-described processing with respect to the channel number “4”, and allocates the channel number “4” and the data number “1” to data having the transfer priority order 9, as illustrated in FIG. 10.

Next, a channel number allocated by the channel allocation unit 33 when the priority control is rotated will be described using FIG. 11. FIG. 11 is a diagram for describing an example of a channel number allocated by the channel allocation unit when the priority control is rotated.

Note that, in the example illustrated in FIG. 11, the channel allocation unit 33 includes five transfer channels #0 to #4, similarly to the example illustrated in FIG. 10. Further, the channel allocation unit 33 changes the transfer channel having the highest degree of priority in the order of the transfer channel #0, the transfer channel #1, the transfer channel #2, the transfer channel #3, and the transfer channel #4. That is, the channel allocation unit 33 selects a transfer channel having the highest degree of priority from among the transfer channels #0 to #4 by the round robin.

In such a case, the channel allocation unit 33 repeatedly executes the processing of allocating the channel numbers of the transfer channels #0 to #4 to data in the descending order form data having the largest data amount. Therefore, as illustrated in FIG. 11, the channel allocation unit 33 sequentially allocates the channel numbers “0” to “4” and allocates the data number “1” to the data having the transfer priority orders of 1 to 5. The channel allocation unit 33 sequentially allocates the channel number “0” to “3” and allocates the data number “2” to the data having the transfer priority orders 6 to 9.

Referring back to FIG. 1, the expectation value generation unit 34 generates an expectation value that is estimation of a transfer result of each of the transfer channels #0 to #7 included in the DMA controller 3 using the data list 25 generated by the data list generation unit 31, the transfer region allocation unit 32, and the channel allocation unit 33. To be specific, the expectation value generation unit 34 acquires the data from the transmission data 13 in the HDD 10, and generates the expectation value of the transfer result by the DMA controller 3 according to the transmission start address, the reception start address, and the transmission data size of each data stored in the data list 25. The expectation value generation unit 34 then stores the generated expectation value in the expectation value region 23.

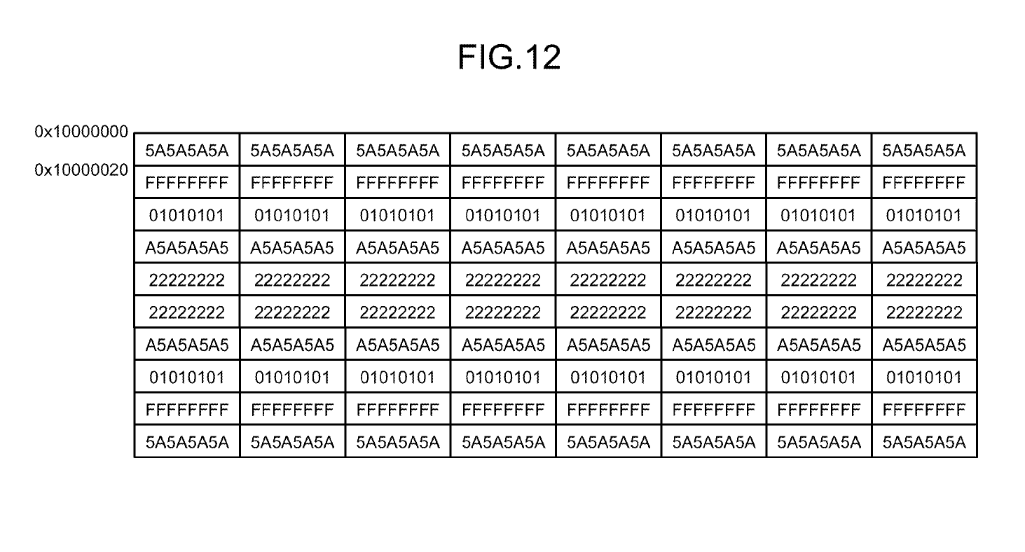

FIG. 12 is a diagram for describing an example of an expectation value. Note that the example of FIG. 12 illustrates an expectation value of when the DMA controller 3 has transferred the data having the transfer priority orders 1 to 5. Further, in the example illustrated in FIG. 12, data having successive “5A”s is data having the transfer priority order 1, data having successive “FF”s is data having the transfer priority order 2, and data having successive “01”s is data of transfer priority order 3. Further, data having successive “A5”s is data of transfer priority order 4, and data having successive “22”s is data of transfer priority order 5.

Further, in the example illustrated in FIG. 12, the transmission start address shifting and the transmission end address shifting are “0x20”. In this case, the expectation value generation unit 34 adjusts central positions of the transfer priority orders 1 to 5, and generates an expectation value in which the data having the transfer priority order 2 is overwritten on the data having the transfer priority order 1, as illustrated in FIG. 12. Hereinafter, similarly, the expectation value generation unit 34 overwrites the transfer priority order 2 with the data having the transfer priority order 3, overwrites the data having the transfer priority order 3 with the data having the transfer priority order 4, and the data having the transfer priority order 4 with the data having the transfer priority order 5. Note that the data having the transfer priority orders 1 to 5 decrease the data amounts in incremental steps. Therefore, all pieces of data are not lost even if data having a lower priority order is overwritten.

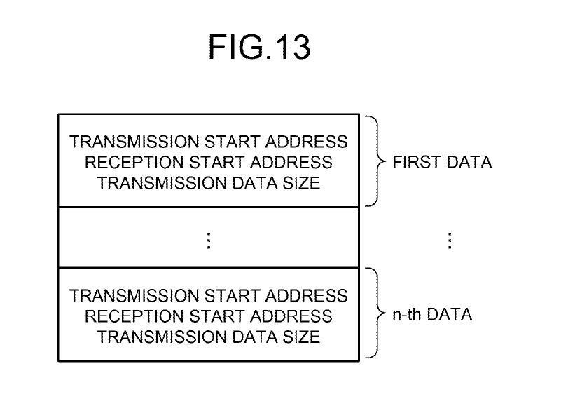

Referring back to FIG. 1, the descriptor setting unit 35 generates the descriptor for each transfer channel included in the DMA controller 3 according to the data list 25. Hereinafter, description will be given using the drawing. FIG. 13 is a diagram for describing an example of the descriptor. The descriptor setting unit 35 determines the order of data to be transferred, a transmission start address, a reception start address, a transmission data size, and the like for each transfer channel according to the data list 25. Then, the descriptor setting unit 35 generates the descriptor that stores the determined information, for each data, and chains the generated descriptors for each transfer channel.

Referring back to FIG. 1, when the descriptor setting unit 35 has generated the descriptor, the DMA start-up unit 36 initializes the reception region 22 and the error list 24. The DMA start-up unit 36 then transmits the descriptor generated by the descriptor setting unit 35 to the DMA controller 3. That is, the DMA start-up unit 36 instructs transfer of the data according to the descriptor to the transfer channels #0 to #7 included in the DMA controller 3.

When the operations of the transfer channels #0 to #7 included in the DMA controller 3 have been completed, the data comparison unit 37 compares whether the data stored in the reception region 22 and the expectation value stored in the expectation value region 23 coincide with each other. When determining that the data stored in the reception region 22 and the data stored in the expectation value region 23 do not coincide with each other, the data comparison unit 37 then executes following processing. That is, the data comparison unit 37 stores, in the error list 24, an error address in which the data not coinciding with each other are stored, and the number of errors that is the number of addresses not coinciding with each other.

For example, the data comparison unit 37 reads out the expectation value stored in the expectation value region 23 and the data stored in the reception region 22 by four bytes from respective heads, and determines whether the read out data coincide with each other. The data comparison unit 37 then compares the read out data, newly reads out next four bytes of the respective read out data when the data coincide with each other, and determine whether the read out data coincide with each other again. Meanwhile, when the read out data do not coincide with each other, the data comparison unit 37 stores, in the error list 24, error addresses that are addresses in which the data not coinciding with each other, and the number of errors that is the number of addresses not coinciding with each other.

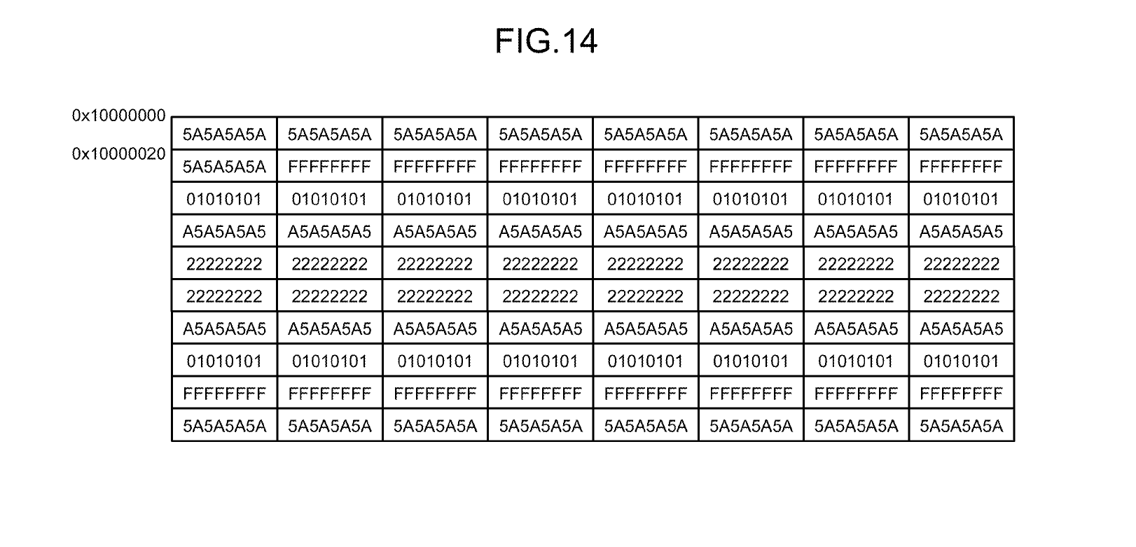

Here, FIG. 14 is a diagram for describing an example of data stored in the reception region when the priority control is not accurately performed. Note that, in the example illustrated in FIG. 14, the DMA controller 3 transfers data according to the descriptor generated according to the data list from which the expectation value illustrated in FIG. 12 is generated. However, in the example illustrated in FIG. 14, the priority control has not been accurately performed. Therefore, when comparing FIG. 14 with FIG. 12, data of the address of “0x10000020” is “0x5A5A5A5A” while the data was expected to be “0xFFFFFFFF”. Therefore, the data comparison unit 37 stores the error address “0x10000020”, the number of addresses “1”, and the number of errors “1” in the error list 24.

The comparison result unit 38 acquires the error address from the error list 24. The comparison result unit 38 then refers to the data list 25, and acquires the transfer priority order, the channel number, the data number, the transmission start address, the reception start address, and the transmission data size of the data regarding the acquired data address. The comparison result unit 38 then stores the acquired information in the error list 24.

Further, the comparison result unit 38 stores the data of the reception region 22, the data of the expectation value region 23, the error address, and the content of the error list 24 in the HDD 10 as the comparison result 14. Meanwhile, when an error is not detected, that is, when the data of the reception region 22 and the data of the expectation value region 23 coincide with each other, the comparison result unit 38 stores the data of the reception region 22 and the data of the expectation value region 23 in the HDD 10 as the comparison result 14.

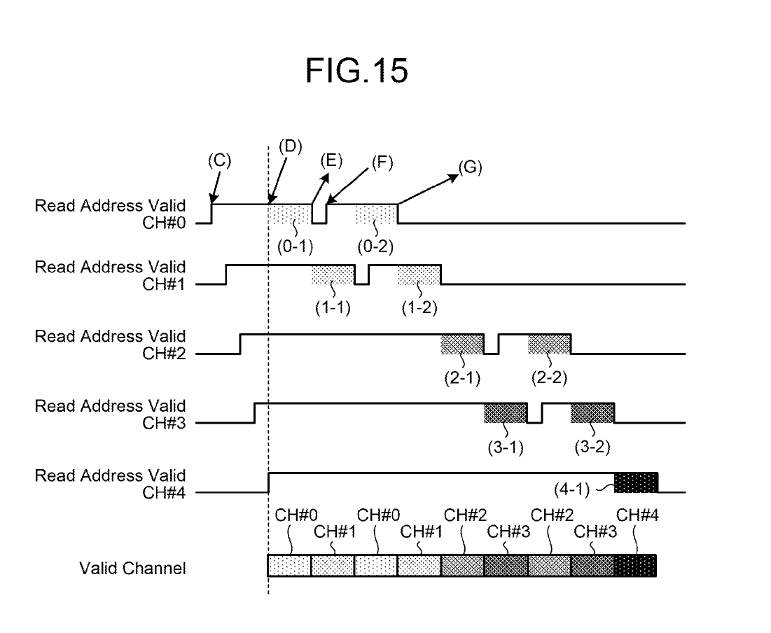

Next, processing in which the DMA controller 3 that has received the descriptor transmits data will be described using FIG. 15. FIG. 15 is a diagram for describing an example in which the DMA controller transmits data according to the descriptor. Note that, in the example illustrated in FIG. 15, the DMA controller 3 includes a plurality of transfer channels #0 to #4, and two pieces of data are allocated to each of the transfer channels #0 to #3, and one piece of data is allocated to the transfer channel #4. Further, the rule of the priority control executed by the DMA controller 3 is rotated. Further, in the example illustrated in FIG. 15, data to which a channel number “n” and a data number “m” are allocated is described as data (n-m).

In this case, data transfer is instructed to the transfer channels #0 to #4 by the descriptor, and as illustrated by (C) in FIG. 15, Read Address Valids CH#0 to CH#4 become “High” in that order from the transfer channel #0. The DMA controller 3 then allocates Valid Channel to the transfer channel #0 having the highest degree of priority at a timing illustrated by (D) in FIG. 15. Therefore, the transfer channel #0 transfers data (0-1) having the channel number of “0” and the data number of “1”, and terminates the transfer at the timing of (E) in FIG. 15 and causes Read Address Valid CH#0 to be “Low”.

Further, after the end of the transfer of the data (0-1) by the transfer channel #0, the DMA controller 3 allocates Valid Channel to the transfer channel #1, and causes the transfer channel #1 to execute transfer of data (1-1) having the channel number of “1” and the data number of “1”. Here, as illustrated by (F) in FIG. 15, the transfer channel #0 causes Read Address Valid #0 to be “High” in order to transfer data (0-2) having the channel number of “0” and the data number of “2”.

Therefore, after the transfer of the data (1-1) by the transfer channel #1, the DMA controller 3 allocates Valid Channel to the transfer channel #0 and causes the transfer channel #0 to transfer the data (0-2). When having been allocated Valid Channel, the transfer channel #0 transfers the data (0-2), and terminates the transfer of data at the timing illustrated by (G) in FIG. 15. Therefore, the transfer channel #0 causes Read Address Valid CH#0 to be “Low”. By repetition of such processing, the DMA controller 3 transfers the pieces of data in the order of the data (0-1), (1-1), (0-2), (1-2), (2-1), (3-1), (2-2), (3-2), and (4-1) in the example illustrated in FIG. 15.

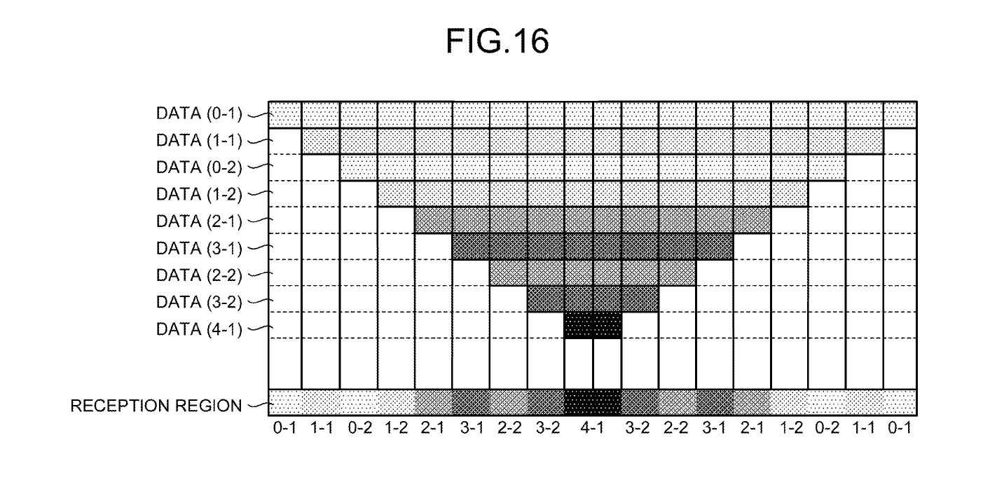

FIG. 16 is a diagram for describing an example of data stored in the reception region 22. Note that the example in FIG. 16 illustrates an example of data stored in the reception region 22 when the DMA controller 3 transfers the data in the order illustrated in FIG. 15. To be specific, FIG. 16 illustrates, regarding the data to be transferred by the DMA controller 3, the data amount and the reception region of the data in the descending order of transfer of data.

That is, the DMA controller 3 first stores the largest data (0-1) among the data (0-1) to (4-1) in the reception region 22. Further, the DMA controller 3 stores the second largest data (1-1) in a region shifted from the region in which the data (0-1) so as to overwrite the data (0-1). Hereinafter, the DMA controller 3 repeats similar processing in the descending order of data amount. That is, the data (0-1) to (4-1) are stored in the reception region 22 while the head positions are shifted in the descending order of data amount.

Therefore, as illustrated in FIG. 16, the data (0-1) to (4-1) overlapping with each other are stored in the reception region 22 in incremental steps. When the data are transferred in the descending order from the largest data while the head positions are shifted, the data overlapping with each other in incremental steps illustrated in FIG. 16 is not obtained if any piece of data is lost, or when the priority control is not accurately performed and the order of transmission of the data is shifted. Therefore, the verification program 30 causes the DMA controller 3 to transfer the plurality of pieces of data to the reception region 22 in the descending order of data amount while shifting the head positions, and confirms the data transferred in the reception region 22, to evaluate the priority control of the DMA controller 3.

Further, as illustrated in FIG. 16, the data is stored in an address shifted by a smaller amount than a difference of data amount between data, so that the data to overwrite fits within the storage region of data to be overwritten. Therefore, the verification program 30 can easily confirm loss of data and a result of the priority control from the data transferred to the reception region 22.

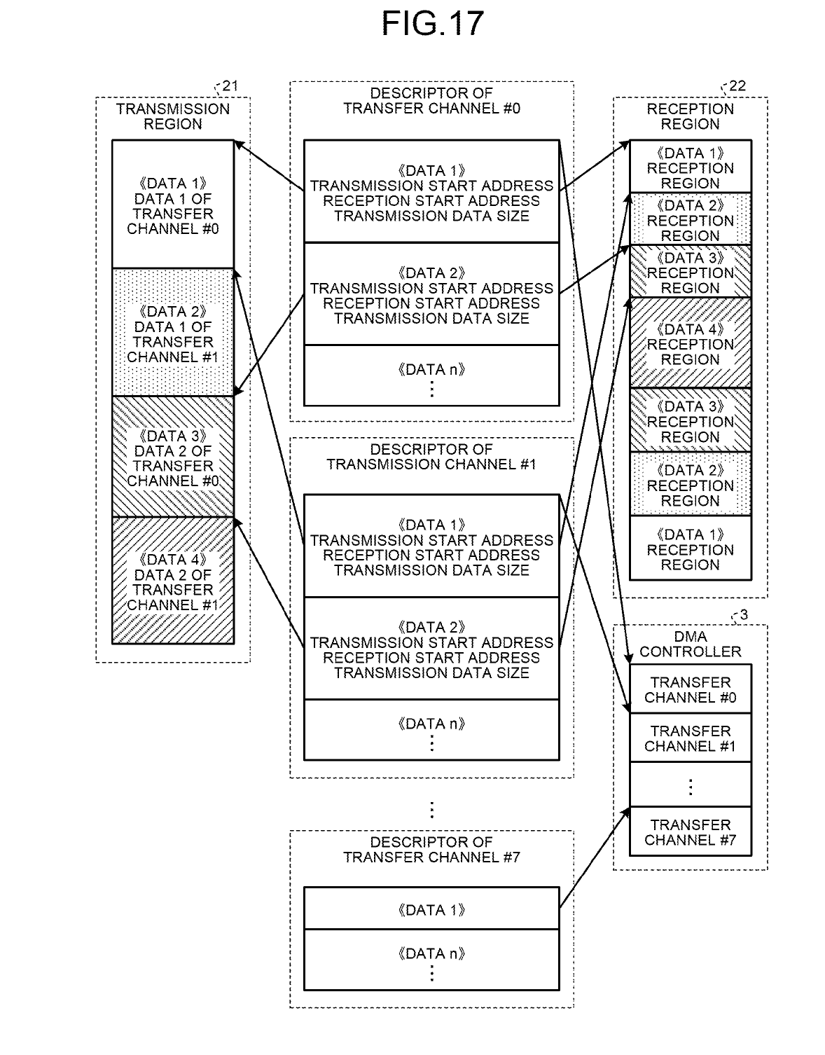

Next, correspondence among the data stored in the transmission region 21, the descriptors of the transfer channels #0 to #7, and the data stored in the reception region 22 will be described using FIG. 17. FIG. 17 is a diagram for describing correspondence among the pieces of data, the descriptor, and the reception region. In the example illustrated in FIG. 17, the descriptor of the data 1 of the transfer channel #0 indicates following information. That is, the descriptor indicates the address of the transmission region 21 that stores data having the largest data amount as a transmission start address, the address that stores data in the reception region 22 as the reception start address, and the data amount of data having the largest data amount indicates the transmission data size.

In addition, the descriptor of the data 2 chained with the descriptor 1 indicates the transmission start address, the reception start address, and the data size to be transmitted to the data having the third largest data amount. Hereinafter, the chained descriptor is allocated to all of the data transferred by the transfer channel #0 to the transfer channel #0. Further, as to other transfer channels #1 to #7, the chained descriptor is allocated to all of the data to be transmitted in the order of individual transfer by the transfer channels #1 to #7.

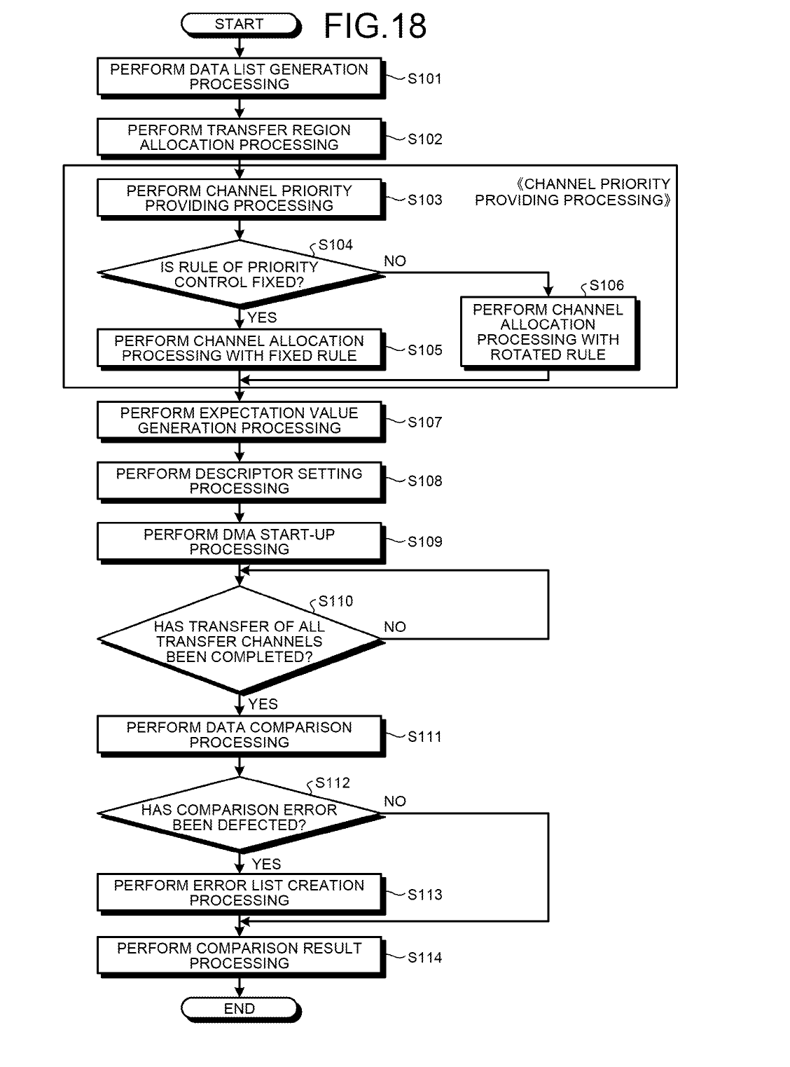

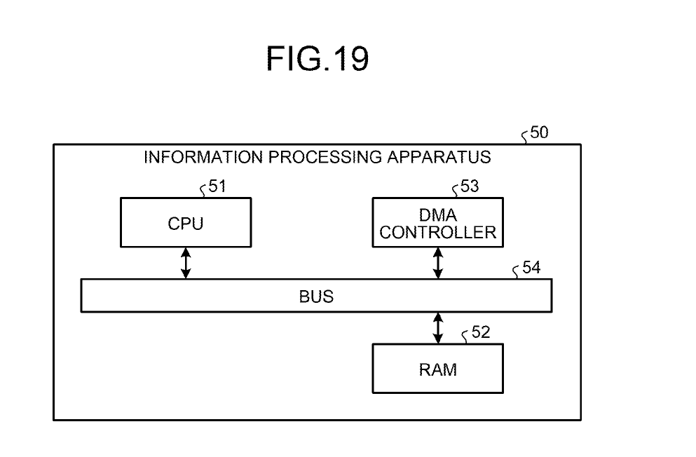

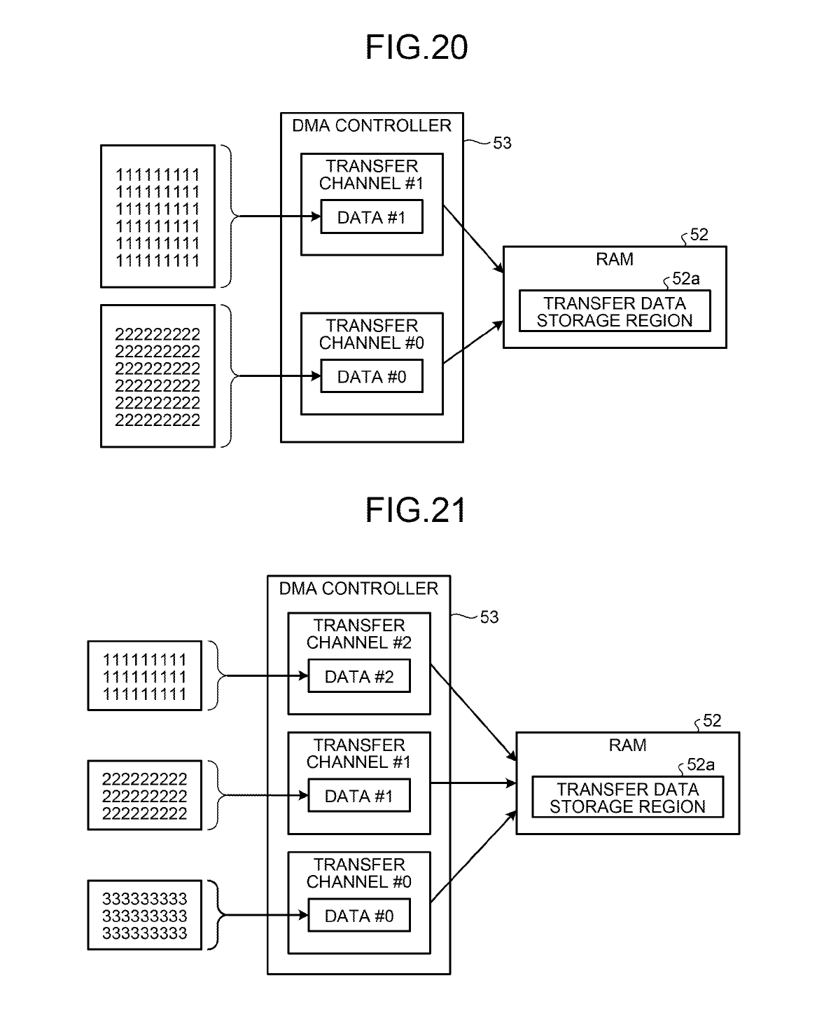

Next, an example of a flow of processing executed by the information processing apparatus 1 according to the verification program 30 will be described using FIG. 18. FIG. 18 is a flowchart for describing an example of processing executed by the information processing apparatus 1 according to the first embodiment.

First, the information processing apparatus 1 executes data list generation processing of generating a data list using the transfer information 12 (step S101). Next, the information processing apparatus 1 fills the generated data list with a transmission start address, a reception start address, and a transmission data size, and executes transfer region allocation processing of generating data to be transmitted (step S102).

Next, the information processing apparatus 1 executes channel allocation processing (steps S103 to S106). For example, the information processing apparatus 1 determines the rule of the priority control of the DMA controller 3 using the operation mode information 11, and executes priority allocation processing of determining the degree of priority allocated to each transfer channel according to the determined rule of the priority control (step S103). Next, the information processing apparatus 1 determines whether the rule of the priority control is fixed (step S104).

Then, when the rule of the priority control is fixed (Yes in step S104), the information processing apparatus 1 executes channel allocation processing with the fixed rule (step S105). That is, the information processing apparatus 1 alternately allocates the channel numbers of the data list 25 in the descending order of the degree of priority to data in the descending order of data amount. Further, when having determined that the rule of the priority control is not fixed (No in step S104), the information processing apparatus 1 executes the channel allocation processing with the rotated rule (step S106). That is, the information processing apparatus 1 repeatedly executes the processing of allocating the channel numbers of the data list 25 in the descending order from a channel number of a transfer channel having a higher degree of priority to data in the descending order from data having a larger data amount until completion of allocation of the channel numbers to all data.

Next, the information processing apparatus 1 generates an expectation value, and execute expectation value generation processing of storing the generated expectation value in the expectation value region 23 (step S107). Next, the information processing apparatus 1 executes descriptor setting processing of generating the descriptor using the data list 25 (step S108). The information processing apparatus 1 then executes DMA start-up processing of transferring data to the DMA controller 3 by transmitting the descriptor to the DMA controller 3 (step S109). Following that, the information processing apparatus 1 determines whether the DMA controller 3 has transferred the data to all of the transfer channels #0 to #7 according to the descriptor (step S110).

In addition, when having determined that the transfer of all data has not been completed (No in step S110), the information processing apparatus 1 determines again, after a predetermined time has passed, whether all data has been transferred (step S110). Further, when having determined that transfer of all data has been completed (Yes in step S101), the information processing apparatus 1 executes data comparison processing of comparing the data stored in the reception region 22 and the expectation value stored in the expectation value region 23 (step S111).

Here, the information processing apparatus 1 determines whether the data stored in the reception region 22 and the expectation value stored in the expectation value region 23 coincides with each other, that is, whether an error has been detected (step S112). When an error has been detected (Yes in step S112), the information processing apparatus 1 then executes error list creation processing of creating an error list 24 (step S113). Meanwhile, when an error has not been verified (No in step S112), the information processing apparatus 1 skips the error list creation processing.

Next, the information processing apparatus 1 executes comparison result processing of storing the content of the error list 24, the data stored in the transmission region 21, and the expectation value stored in the expectation value region 23 as a comparison result 14 in the HDD 10 (step S114). Following that, the information processing apparatus 1 terminates the processing.

As described above, the verification program 30 generates a plurality of pieces of data having different data amounts and a plurality of addresses in which values are shifted. In addition, the verification program 30 associates the addresses with the data in the descending order of data amount, from an address having a smaller value among the plurality of generated addresses. Further, the verification program 30 associates the transfer information of transfer device in the descending order of the degree of priority with the data in the descending order of data amount, from transfer information of a transfer device having a higher degree of allocated priority. Therefore, the verification program 30 can verify execution of the priority control among the transfer channels #0 to #7 by the DMA controller 3.

Further, the verification program 30 can easily verify whether the priority control has been accurately performed by simply executing the program on the actual device without using a logic analyzer. In addition, the verification program 30 can be applied to a mass production test, and the like. In addition, the verification program 30 stores the transmission destination address and a data size of each data to be transferred in the data list 25. Therefore, the verification program 30 can detect a loss of data from the data stored in the reception region 22.

In addition, the verification program 30 determines the rules of the priority control in the transmission channels #0 to #7. The verification program 30 then determines the priority order of the transfer channels #0 to #7 based on the determined rule, and allocates the channel numbers of the transfer channels #0 to #7 to data according to the determined priority order. Therefore, the verification program 30 can verify the execution of the priority control in the transfer channels #0 to #7 included in the DMA controller 3 without depending on the degree of priority of the DMA controller 3.

Further, when the rule of the priority control is fixed, the verification program 30 executes the following processing in the order from the channel number of the transfer device having the highest degree of priority from among the channel numbers not associated with any data. That is, the information processing apparatus 1 alternately associates the channel numbers with the data among data not associated with channel numbers in the descending order from data having the largest data amount by the number of data transmitted by the transfer channel indicated by the channel number.

Therefore, the verification program 30 can generate the descriptor that causes the transmission channels #0 to #7 to transmit data, in the descending order from data having a larger data amount even if the rule of the priority control is fixed. As a result, the verification program 30 can verify appropriate execution of the priority control even if the rule of the priority control among the transfer channels is fixed.

Further, when the rule of the priority control is rotated, the verification program 30 repeatedly executes the processing of associating the channel numbers in the order of the degree of priority allocated to the transmission channels #0 to #7 with data in the descending order from data having a larger data amount. Therefore, the verification program 30 can evaluate appropriate execution of the priority control even if the rule of the priority control among the transfer channels is rotated.

Further, when generating addresses having different values in incremental steps, the verification program 30 generates an address having a difference smaller than a different of the data amount in data generated in incremental steps. Therefore, the verification program 30 can perform transmission of data such that data other than both ends of the data lastly stored is overwritten with the data stored in the reception region 22. As a result, the verification program 30 can easily perform evaluation based on the data stored in the reception region 22.

Further, the verification program 30 generates an expectation value based on the data list 25 in advance, determines whether the generated expectation value and a transfer result coincide with each other, and evaluates that the priority control has been accurately performed when the expectation value and the transfer result coincide with each other. Therefore, the verification program 30 can evaluate the execution of the priority control of the transmission channels #0 to #7 included in the DMA controller 3.

### [b] Second Embodiment

While an embodiment of the present invention has been described so far, embodiments may be implemented in various different forms other than the above-described embodiment. Therefore, hereinafter, other embodiments included in the present invention will be described as a second embodiment.

(1) The Number of Transfer Channels

The above-described DMA controller 3 includes eight transfer channels #0 to #7. However, embodiments are not limited to this example, and the DMA controller 3 may include an arbitrary number of transfer channels #0 to #7. That is, the verification program 30 can evaluate the execution of the priority control among transfer devices without depending on the number of transfer devices to be evaluated.

(2) Transfer Device

In the above-described the first embodiment, the verification program 30 that evaluates whether the priority control in the DMA controller 3 having the plurality of transfer channels #0 to #7 has been accurately performed. However, embodiments are not limited to this example, and the verification program 30 can evaluate not only the priority control among a plurality of channels included in one device, but also the priority control among a plurality of devices. That is, when the priority control is being executing among a plurality of transfer devices, the verification program 30 can evaluate execution of the priority control among arbitral devices.

(3) Descriptor

The above-described verification program 30 generates the data list 25, generates the descriptor based on the generated data list 25, and causes the transfer channels #0 to #7 to transfer data using the generated descriptor. However, embodiments are not limited to this example. For example, the verification program 30 may perform following processing in a case of evaluating the priority control among the plurality of transfer devices that transmits a packet. That is, the verification program 30 may generate a packet transmission table, allocate data to each transfer device based on the generated packet transmission table, and cause each transfer device to transmit the packet.

That is, the verification program 30 may just identify the order of transmission of data by each transfer device based on the priority order among the transfer devices, and transmit a plurality of pieces of data having different data amounts in the descending order from data having a larger data amount using the identified order. The value of the data list 25 exemplarily illustrated in the first embodiment is an example, and the verification program 30 can set arbitrary values regarding the channel number, the data number, the transmission start address, the reception start address, the transmission data size.

(4) Data to be Transmitted

The above-described verification program 30 generates data to be transferred from the transmission data 13 stored in the HDD 10. However, embodiments are not limited to this example. For example, information indicating a test pattern of data to be transferred is stored in the transfer information 12 in advance. The transfer region allocation unit 32 then browses the transfer information 12 and when the information indicating a test pattern indicates increment data, the transfer region allocation unit 32 may generate increment data as each data to be transferred. Further, when the information indicating a test pattern indicates random data, the transfer region allocation unit 32 may generate random data as each data to be transferred.

Note that the verification program 30 can be realized by execution of a program prepared in advance in a computer such as a personal computer or a work station. This program can be distributed through a network such as the Internet. Further, this program is recorded in a recording medium readable by a computer, such as a hard disk, a flexible disc (FD), a compact disc read only memory (CD-ROM), a magneto optical disc (MO) a digital versatile disc (DVD). Further, this program can be executed by being read out from the recording medium by a computer.

According to an aspect of an embodiment, execution of priority control of a transfer device can be verified.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a verification program executed by an information processing apparatus configured to verify priority control among a plurality of transfer devices to which different degrees of priority are respectively allocated, the verification program causing the information processing apparatus to execute a process comprising:
firstly generating a plurality of pieces of data having different data amounts;
secondly generating a plurality of addresses in which a value is shifted;
firstly associating the generated addresses in an ascending order of value of address with the plurality of generated pieces of data in a descending order of data amount;
secondly associating device information indicating the transfer devices in a descending order of the degree of priority allocated to the transfer devices with the plurality of generated pieces of data in the descending order of data amount;
instructing transfer of a generated piece of data to the address associated with the data, to the transfer device indicated by the device information associated with the data; and
verifying the degree of priority among the plurality of transfer devices according to a result of the transfer of the data by the plurality of transfer devices.

2. The computer-readable recording medium according to claim 1, wherein the process further comprises:
firstly determining a rule of the priority control among the plurality of transfer devices; and
secondly determining an order of the degree of priority allocated to the transfer devices based on the determined rule.

3. The computer-readable recording medium according to claim 2, wherein the firstly associating, when the rule of the priority control is a rule of selecting a transfer device having a highest degree of priority by a round robin system, repeatedly associates the device information with the plurality of generated pieces of data in the descending order of data amount according to an order selected by the rule of the priority control until the device information is associated with all of the generated pieces of data.

4. The computer-readable recording medium according to claim 2, wherein the process further comprises, when there is a transfer device that transfers a plurality of pieces of data, and the rule of the priority control is a rule of fixing the degree of priority allocated to each transfer device, determining the number of pieces of data to be transmitted by each transfer device, and
the secondly associating associates, when the rule of the priority control is a rule of fixing the degree of priority allocated to each transfer device, the device information indicating a transfer device having a highest degree of priority among the device information not associated with any piece of data with data having a largest data amount among the data not associated with the device information, and alternately associates the device information with data associated with the device information in the descending order of data amount until the device information is associated with all of the generated pieces of data.

5. The computer-readable recording medium according to claim 1, wherein the verifying includes
estimating a transfer result of each of the generated pieces of data in advance based on the data, the address allocated to the data, and the device information allocated to the data,
determining whether the estimated transfer result and a result of actual transfer of the data by the transfer device coincide with each other, and
when having determined that the estimated transfer result and the result of actual transfer of the data by the transfer device coincide with each other, outputting evaluation indicating an accurate operation of the transfer device.

6. The computer-readable recording medium according to claim 5, wherein a difference of a value among the generated addresses is smaller than a difference of a data amount among the generated pieces of data.

7. The computer-readable recording medium according to claim 5, wherein the process comprises generating a plurality of pieces of data in which different values are respectively stored.

8. An information processing apparatus configured to verify priority control among a plurality of transfer devices to which different degrees of priority are respectively allocated, the information processing apparatus comprising:
a data generation unit configured to generate a plurality of pieces of data having different data amounts;
an address generation unit configured to generate a plurality of addresses in which a value is shifted;
an association unit configured to associate the addresses generated by the address generation unit in an ascending order of value of address with the plurality of pieces of data generated by the data generation unit in a descending order of data amount, and to associate device information indicating the transfer devices in a descending order of the degree of priority allocated to the transfer devices with the plurality of pieces of data generated by the data generation unit in a descending order of data amount;
an instruction unit configured to instruct transfer of a piece of data generated by the data generation unit to the addresses associated with the data by the association unit, to the transfer device indicated by the device information associated with the data; and
a verification unit configured to verify the degree of priority among the plurality of transfer devices according to a result of the transfer of the data by the plurality of transfer devices.

9. A verification method of a transfer device executed by an information processing apparatus configured to verify priority control among a plurality of transfer devices to which different degrees of priority are respectively allocated, the verification method comprising:
firstly generating a plurality of pieces of data having different data amounts;
secondly generating a plurality of addresses in which a value is shifted;
firstly associating the generated addresses in an ascending order of value of address with the plurality of generated pieces of data in a descending order of data amount;
secondly associating device information indicating the transfer devices in a descending order of the degree of priority allocated to the transfer devices with the plurality of generated pieces of data in the descending order of data amount;
instructing transfer of a generated piece of data to the address associated with the data, to the transfer device indicated by the device information associated with the data; and
verifying the degree of priority among the plurality of transfer devices according to a result of the transfer of the data by the plurality of transfer devices.
